(19) United States
(12) Patent Application Publication
(10) Pub. No.: US 2017/0223924 A1
(43) Pub. Date: Aug. 10, 2017

(54) PET CARRIER INCLUDING DETACHABLE LITTER BOX

(71) Applicant: Renee Richetto GRUL, The Villages, FL (US)

(72) Inventor: Renee Richetto GRUL, The Villages, FL (US)

(21) Appl. No.: 15/426,419

(22) Filed: Feb. 7, 2017

Related U.S. Application Data
(60) Provisional application No. 62/292,893, filed on Feb. 9, 2016.

(51) Int. Cl. A01K 1/01; A01K 1/015; A01K 1/02; A01K 1/00

(52) U.S. Cl. CPC A01K 1/0114; A01K 1/0035; A01K 1/0151; A01K 1/0064; A01K 1/0152; A01K 1/0236

(57) ABSTRACT

A pet carrier assembly, including: an upper cage housing; and a lower litter pan coupled to the upper cage housing; wherein the lower litter pan is detachable from the upper cage housing and includes a removable waste grate disposed in a bottom portion thereof. The upper cage housing includes a hinged door structure operable for providing access to an interior portion of the upper cage housing. The upper cage housing includes one or more window grates or arrays of holes operable for providing ventilation to an interior portion of the upper cage housing. The pet carrier assembly also includes one or more coupling mechanisms for coupling the lower litter pan to the upper cage housing. Optionally, the pet carrier assembly further includes a moisture absorbent material disposed between the removable waste grate and a bottom of the lower litter pan.

### CROSS-REFERENCE TO RELATED APPLICATION

The present patent application/patent claims the benefit of priority of co-pending U.S. Provisional Patent Application No. 62/292,893, filed on Feb. 9, 2016, and entitled “PET CARRIER INCLUDING DETACHABLE LITTER BOX,” the contents of which are incorporated in full by reference herein.

### FIELD OF THE INVENTION

The present invention relates generally to the pet care field. More specifically, the present invention relates to a pet carrier including a detachable litter box. The detachable litter box utilizes a removable grate through which pet waste may pass when a pet is housed and/or transported therein. The detachable litter box may also be attached to the bottom of a conventional pet carrier for use and/or storage via an optional strap.

### BACKGROUND OF THE INVENTION

A variety of conventional pet carriers are well known to those of ordinary skill in the art. These pet carriers are typically manufactured from a plastic or metallic mesh material. When a pet is disposed therein, papers or the like may be disposed in the bottom of the pet carrier to catch and retain pet waste. This is uncomfortable and unsanitary for the pet and a user alike. In response, some pet carriers have been developed that incorporate a metallic mesh bottom and a removable litter draw or the like. Disadvantageously, such pet carriers are difficult to clean and fail to provide a mobile litter box.

Accordingly, what is still needed in the art is a pet carrier that includes a detachable litter box that is easy to use and clean. The detachable litter box should utilize a removable grate through which pet waste may pass when a pet is housed and/or transported therein. The detachable litter box should also be capable of being attached to the bottom of a conventional pet carrier for use and/or storage via an optional strap.

### BRIEF SUMMARY OF THE INVENTION

In various exemplary embodiments, the present invention provides such a pet carrier that includes a detachable litter box that is easy to use and clean. The detachable litter box utilizes a removable grate through which pet waste may pass when a pet is housed and/or transported therein. The detachable litter box is also capable of being attached to the bottom of a conventional pet carrier for use and/or storage via an optional strap.

In one exemplary embodiment, the present invention provides a pet carrier assembly, including: an upper cage housing; and a lower litter pan coupled to the upper cage housing; wherein the lower litter pan is detachable from the upper cage housing and includes a removable waste grate disposed in a bottom portion thereof. The upper cage housing includes a hinged door structure operable for providing access to an interior portion of the upper cage housing. The upper cage housing includes one or more window grates operable for providing ventilation to an interior portion of the upper cage housing. Alternatively, the upper cage housing includes one or more arrays of holes operable for providing ventilation to an interior portion of the upper cage housing. Finally, the upper cage housing includes a handle operable for allowing the upper cage housing to be lifted. The pet carrier assembly also includes one or more coupling mechanisms for coupling the lower litter pan to the upper cage housing. The lower litter pan includes a cut away operable for providing access to an interior portion of the lower litter pan. Optionally, the pet carrier assembly further includes a moisture absorbent material disposed between the removable waste grate and a bottom of the lower litter pan.

In another exemplary embodiment, the present invention provides a method for providing a pet carrier assembly, including: providing an upper cage housing; and providing a lower litter pan coupled to the upper cage housing; wherein the lower litter pan is detachable from the upper cage housing and includes a removable waste grate disposed in a bottom portion thereof. The upper cage housing includes a hinged door structure operable for providing access to an interior portion of the upper cage housing. The upper cage housing includes one or more window grates operable for providing ventilation to an interior portion of the upper cage housing. Alternatively, the upper cage housing includes one or more arrays of holes operable for providing ventilation to an interior portion of the upper cage housing. Finally, the upper cage housing includes a handle operable for allowing the upper cage housing to be lifted. The method for providing a pet carrier assembly also includes providing one or more coupling mechanisms for coupling the lower litter pan to the upper cage housing. The lower litter pan includes a cut away operable for providing access to an interior portion of the lower litter pan. Optionally, the method for providing a pet carrier assembly further includes providing a moisture absorbent material disposed between the removable waste grate and a bottom of the lower litter pan.

In a further exemplary embodiment, the present invention provides a detachable litter box for a pet carrier assembly, including: a lower litter pan configured to be coupled to one or more of an upper cage housing and a lower cage housing of the pet carrier assembly; wherein the lower litter pan is detachable from the one or more of the upper cage housing and the lower cage housing of the pet carrier assembly and includes a removable waste grate disposed in a bottom portion thereof. The detachable litter box for a pet carrier assembly also includes one or more coupling mechanisms for coupling the lower litter pan to the one or more of the upper cage housing and the lower cage housing of the pet carrier assembly. The lower litter pan includes a cut away operable for providing access to an interior portion of the lower litter pan. Optionally, the detachable litter box for a pet carrier assembly further includes a moisture absorbent material disposed between the removable waste grate and a bottom of the lower litter pan.

### BRIEF DESCRIPTION OF THE DRAWINGS

The present invention is illustrated and described herein with reference to the various drawings, in which like reference numbers are used to denote like assembly components/reference numbers, as appropriate, and in which:

FIG. 1 is a planar front view of one exemplary embodiment of the pet carrier including a detachable litter box of the present invention;

FIG. 2 is a planar side view of one exemplary embodiment of the pet carrier including a detachable litter box of the present invention; and

FIGS. 3a and 3b are front and top planar view of one exemplary embodiment of the detachable litter box of the present invention.

### DETAILED DESCRIPTION OF THE INVENTION

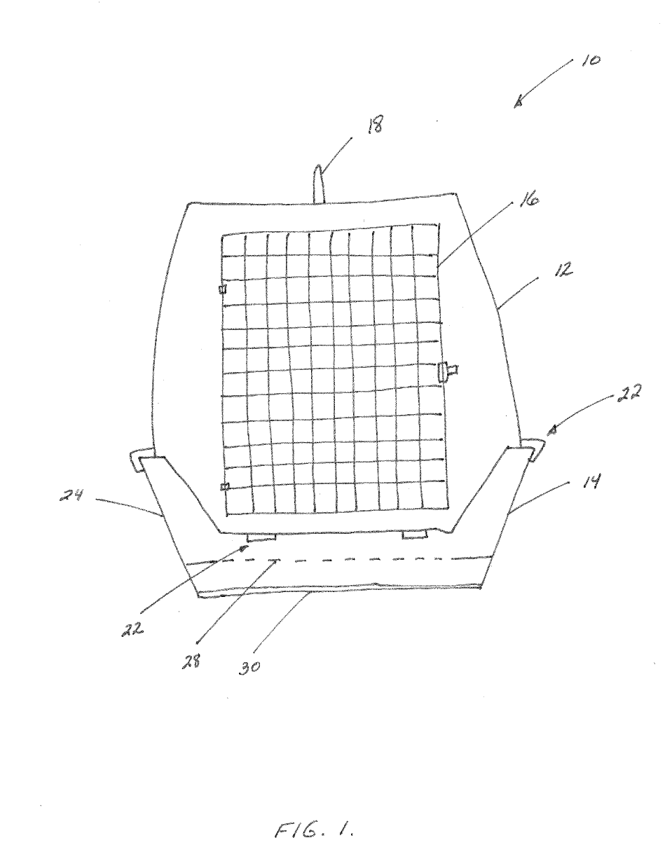

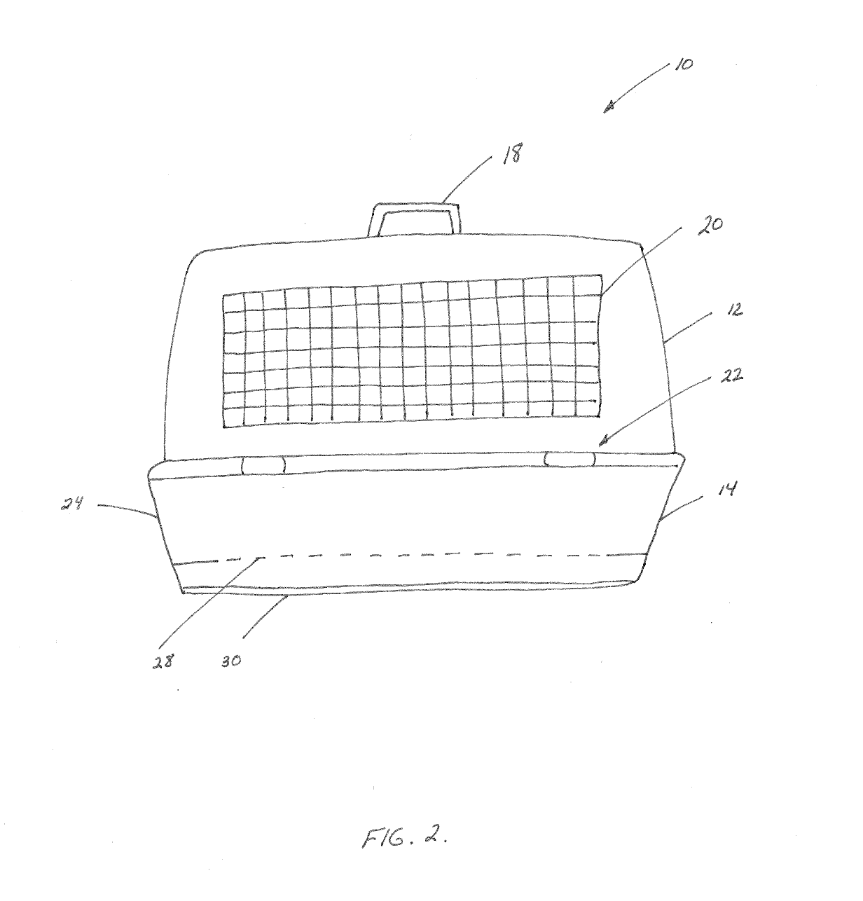

Referring now specifically to FIGS. 1 and 2, in one exemplary embodiment, the pet carrier 10 of the present invention includes a cage housing 12 and a detachable litter box 14. As with conventional pet carriers, the cage housing 12 includes a prismatic lid or roof structure that is manufactured from a rigid plastic or metallic mesh material. The cage housing 12 may also be manufactured from a semi-rigid or flexible plastic or fabric material, optionally including a rigid internal or external support frame structure. One or more hinged latching door grates or other structures 16 (FIG. 1) are provided through which a pet may be disposed in/removed from the pet carrier 10. A handle 18 is provided by which the pet carrier 10 may be carried. One or more additional window grates or other structures 20 (FIG. 2) are also provided in order to provide adequate ventilation to a pet disposed within the pet carrier 10. These additional window grates or other structures 20 may simply take the form of arrays of ventilation holes disposed through the front, back, and/or sides, of the cage housing 12. The cage housing 12 is appropriately sized to adequately accommodate an intended pet, such as a rodent, a cat, a small dog, a large dog, an exotic animal, etc. In the exemplary embodiment illustrated, the cage housing 12 has a slightly tapering cross-sectional area from bottom to top, although this is not absolutely necessary.

The cage housing 12 is selectively coupled to the detachable litter box 14 via a plurality of brackets, clips, thumb screws, and or the like 22. Optionally, the bottom (open) edge of the cage housing 12 sits on a shelf or within a recess manufactured into the top (open) edge of the litter pan 24 of the detachable litter box 14. Alternatively, the top (open) edge of the litter pan 24 contacts a shelf or sits within a recess manufactured into the bottom (open) edge of the cage housing 12. In general, the litter pan 24 includes a typical prismatic pan or tray structure manufactured from a rigid plastic or metallic material. The litter pan 24 may also be manufactured from a semi-rigid or flexible plastic or fabric material, optionally including a rigid internal or external support frame structure.

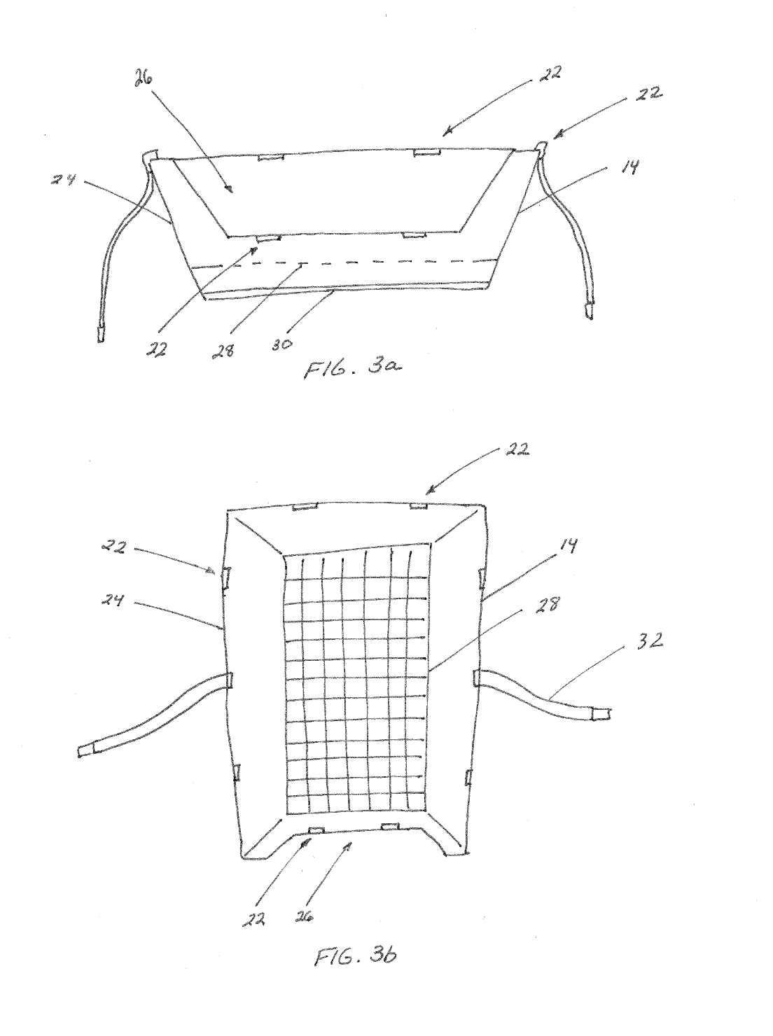

Referring now specifically to FIGS. 3a and 3b, in one exemplary embodiment, the litter pan 24 may have sides of substantially equal height or it may include a cut away 26 in one or both ends for accommodating the one or more hinged latching door grates or other structures 16 (FIG. 1) and/or providing easier pet access. In the exemplary embodiment illustrated, the litter pan 24 has a slightly tapering cross-sectional area from top to bottom, although this is not absolutely necessary. Preferably, the litter pan 24 is manufactured such that it is impervious to and retains any liquids disposed within the pet carrier 10.

A waste grate 28 through which liquids and small solids may pass is disposed within and forms the pet floor of the litter pan 24. This waste grate 28 sits within a frame structure, on a ledge structure, and/or on one or more support structures manufactured into/disposed within the litter pan 24, such that the waste grate 28 is held spaced apart from the bottom of the litter pan 24, thereby allowing pet waste to pass through the waste grate 28 and into/onto the bottom of the litter pan 24. Optionally, the bottom of the litter pan 24 is lined with a moisture-absorbent pad or the like 30. Litter may also be used for this purpose. It should be noted that the waste grate 28 may cover all or only a selected portion of the bottom of the litter pan 24. Preferably, the waste grate 28 is removable for convenient cleaning of the detachable litter box 14 when it is decoupled from the cage housing 12.

Optionally, the detachable litter box 14 includes one or more straps or other attachment mechanisms that allow it to be secured to the upper (and optionally lower) housing of another (conventional) pet carrier, for use and/or storage.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims.

What is claimed is:

1. A pet carrier assembly, comprising:
an upper cage housing; and
a lower litter pan coupled to the upper cage housing;
wherein the lower litter pan is detachable from the upper cage housing and comprises a removable waste grate disposed in a bottom portion thereof.

2. The pet carrier assembly of claim 1, wherein the upper cage housing comprises a hinged door structure operable for providing access to an interior portion of the upper cage housing.

3. The pet carrier assembly of claim 1, wherein the upper cage housing comprises one or more window grates operable for providing ventilation to an interior portion of the upper cage housing.

4. The pet carrier assembly of claim 1, wherein the upper cage housing comprises one or more arrays of holes operable for providing ventilation to an interior portion of the upper cage housing.

5. The pet carrier assembly of claim 1, wherein the upper cage housing comprises a handle operable for allowing the upper cage housing to be lifted.

6. The pet carrier assembly of claim 1, further comprising one or more coupling mechanisms for coupling the lower litter pan to the upper cage housing.

7. The pet carrier assembly of claim 1, wherein the lower litter pan comprises a cut away operable for providing access to an interior portion of the lower litter pan.

8. The pet carrier assembly of claim 1, further comprising a moisture absorbent material disposed between the removable waste grate and a bottom of the lower litter pan.

9. A method for providing a pet carrier assembly, comprising:
providing an upper cage housing; and
providing a lower litter pan coupled to the upper cage housing;
wherein the lower litter pan is detachable from the upper cage housing and comprises a removable waste grate disposed in a bottom portion thereof.

10. The method for providing a pet carrier assembly of claim 9, wherein the upper cage housing comprises a hinged door structure operable for providing access to an interior portion of the upper cage housing.

11. The method for providing a pet carrier assembly of claim 9, wherein the upper cage housing comprises one or more window grates operable for providing ventilation to an interior portion of the upper cage housing.

12. The method for providing a pet carrier assembly of claim 9, wherein the upper cage housing comprises one or more arrays of holes operable for providing ventilation to an interior portion of the upper cage housing.

13. The method for providing a pet carrier assembly of claim 9, wherein the upper cage housing comprises a handle operable for allowing the upper cage housing to be lifted.

14. The method for providing a pet carrier assembly of claim 9, further comprising providing one or more coupling mechanisms for coupling the lower litter pan to the upper cage housing.

15. The method for providing a pet carrier assembly of claim 9, wherein the lower litter pan comprises a cut away operable for providing access to an interior portion of the lower litter pan.

16. The method for providing a pet carrier assembly of claim 9, further comprising providing a moisture absorbent material disposed between the removable waste grate and a bottom of the lower litter pan.

17. A detachable litter box for a pet carrier assembly, comprising:
a lower litter pan configured to be coupled to one or more of an upper cage housing and a lower cage housing of the pet carrier assembly;
wherein the lower litter pan is detachable from the one or more of the upper cage housing and the lower cage housing of the pet carrier assembly and comprises a removable waste grate disposed in a bottom portion thereof.

18. The detachable litter box for a pet carrier assembly of claim 17, further comprising one or more coupling mechanisms for coupling the lower litter pan to the one or more of the upper cage housing and the lower cage housing of the pet carrier assembly.

19. The detachable litter box for a pet carrier assembly of claim 17, wherein the lower litter pan comprises a cut away operable for providing access to an interior portion of the lower litter pan.

20. The detachable litter box for a pet carrier assembly of claim 17, further comprising a moisture absorbent material disposed between the removable waste grate and a bottom of the lower litter pan.
